(19) United States
(12) Patent Application Publication
(10) Pub. No.: US 2023/0406195 A1
(43) Pub. Date: Dec. 21, 2023

(54) SYSTEMS AND METHODS FOR AUTOMATED HEADLAMP ADJUSTMENTS FOR AUTONOMOUS VEHICLES

(71) Applicant: TuSimple, Inc., San Diego, CA (US)

(72) Inventors: Niranjan Shenoy Bellare, Canton, MI (US); Xiaoling Han, San Diego, CA (US)

(21) Appl. No.: 18/323,295

(22) Filed: May 24, 2023

Related U.S. Application Data
(60) Provisional application No. 63/366,433, filed on Jun. 15, 2022.

(51) Int. Cl. B60Q 1/115; B60Q 1/12; B60W 60/00

(52) U.S. Cl. CPC B60Q 1/115; B60Q 1/122; B60W 60/001; B60Q 2300/322; B60Q 2300/142; B60Q 2300/45; B60Q 2300/13; B60W 30/18163

(57) ABSTRACT

Systems and methods for automated headlamp adjustments for autonomous vehicles are disclosed. In one aspect, an autonomous vehicle includes at least one headlamp configured to generate and emit light to illuminate an environment of the autonomous vehicle, at least one actuator configured to adjust a direction in which the light is emitted from the at least one headlamp, and at least one perception sensor configured to generate perception data based at least in part on the light emitted from the at least one headlamp. The autonomous vehicle further includes a processor configured to receive one or more inputs including a navigational map, determine a headlamp angle based at least in part on the navigational map, and provide a command to the at least one actuator to adjust an orientation of the at least one headlamp based on the headlamp angle.

### CROSS-REFERENCE TO RELATED APPLICATION(S)

This application claims the benefit of U.S. Provisional Application No. 63/366,433, filed Jun. 15, 2022. The foregoing application is hereby incorporated by reference in its entirety. Any and all applications for which a foreign or domestic priority claim is identified in the Application Data Sheet as filed with the present application are hereby incorporated by reference under 37 CFR 1.57.

### FIELD

The present disclosure relates generally to autonomous vehicles. More particularly, the present disclosure is related to systems and methods for automatically adjusting headlamps for autonomous driving.

### DESCRIPTION OF THE RELATED TECHNOLOGY

One aim of autonomous vehicle technologies is to provide vehicles that can safely navigate towards a destination with limited or no driver assistance. One aspect that affects the safe navigation of an autonomous vehicle (AV) is the accurate perception of the driving environment. Certain sensors, such as camera(s) and/or LiDAR, may be affected by the current lighting conditions of the environment.

### SUMMARY OF CERTAIN INVENTIVE ASPECTS

In inventive aspect is an autonomous vehicle comprising: at least one headlamp configured to emit light in a direction to illuminate an environment of the autonomous vehicle; at least one actuator configured to adjust the direction; at least one perception sensor configured to generate data based at least in part on the light emitted from the at least one headlamp; and a processor configured to: receive one or more inputs including a navigational map, determine a headlamp angle based at least in part on the navigational map, and provide a command to the at least one actuator to adjust the direction based on the headlamp angle.

The one or more inputs can further include a steering angle, and the processor is further configured to: determine a baseline horizontal headlamp angle based on the steering angle.

The baseline horizontal headlamp angle can be further determined based on a linear relationship with the steering angle.

The one or more inputs can further include a turn signal, and the processor is further configured to: adjust the baseline horizontal headlamp angle based on the turn signal.

The processor can be further configured to: determine a road curvature based on the navigational map, wherein determining the headlamp angle is further based at least in part on the road curvature.

The headlamp angle can be determined based on the road curvature illuminating a portion of the road curvature within range of the light emitted by the at least one headlamp.

The headlamp angle can be determined based on the road curvature taking into account for the road curvature of a roadway not yet within range of the light emitted by the headlamps.

The one or more inputs can further include a trajectory of the autonomous vehicle.

The headlamp angle can be determined based on the trajectory sufficiently illuminating a roadway corresponding to the trajectory of the autonomous vehicle.

The one or more inputs can further include a steering angle, a turn signal input, and a trajectory of the autonomous vehicle, and the processor is further configured to: determine that the autonomous vehicle will or is currently executing a lane change, wherein determining the headlamp angle is further based on the determination that the autonomous vehicle will or is currently executing the lane change.

Another aspect is a method performed by a processor of an autonomous vehicle, comprising: receiving one or more inputs including a navigational map; determining a headlamp angle based at least in part on the navigational map; and providing a command to at least one actuator to adjust an orientation of at least one headlamp based on the headlamp angle.

The one or more inputs can further include a request identifying a point of interest, and wherein determining the headlamp angle is further based on the point of interest.

The at least one headlamp can comprise a plurality of headlamps, the one or more inputs can further include a plurality of requests, each of the requests identifying a corresponding point of interest, determining the headlamp angle comprises determining a headlamp angle for each of the plurality of headlamps based on one of the points of interest, and providing the command comprises providing a command to each of the plurality of headlamps based on the corresponding headlamp angles.

The one or more inputs can further include at least one of the following: a weather input, current lighting, current traffic conditions, feedback from one or more perception sensors of the autonomous vehicle, and a time of day.

The one or more inputs can further comprise receiving feedback from a camera of the autonomous vehicle indicating there is a certain region within a field of view of the camera that has a measured level of illumination below a threshold, and determining the headlamp angle is further based on the feedback from the camera.

The method can further comprise: determining a road slope based on the navigational map; and determining a baseline headlamp angle based at least in part on the road slope.

The one or more inputs can further comprise at least one of a suspension status, cabin inertial sensor (IMU) data, and chassis IMU data, and the method further comprises: determining an orientation of the autonomous vehicle based on the one or more inputs; and adjusting the baseline headlamp angle based on the orientation of the autonomous vehicle, wherein determining the headlamp angle is further based on the adjusted baseline headlamp angle.

Another aspect is a non-transitory computer-readable medium having stored thereon instructions that, when executed by a processor, cause the processor to: receive one or more inputs including a navigational map; determine a headlamp angle based at least in part on the navigational map; and provide a command to at least one actuator to adjust an orientation of at least one headlamp based on the headlamp angle.

The determined headlamp angle can comprise a horizontal headlamp angle and a vertical headlamp angle.

The horizontal headlamp angle and the vertical headlamp angle can be determined independently.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates a schematic diagram of a system including an autonomous vehicle.

FIG. 2 shows a flow diagram for operation of an autonomous vehicle (AV) safely in light of the health and surroundings of the AV.

FIGS. 3A and 3B illustrate an autonomous vehicle having one or more headlamps in accordance with aspects of this disclosure.

FIG. 4A is a block diagram illustrating an embodiment of a horizontal headlamp control algorithm that can be run by the in-vehicle control computer (VCU) for adjusting the horizontal headlamp angle in accordance with aspects of this disclosure.

FIG. 4B is a block diagram illustrating an embodiment of a vertical control algorithm that can be run by the VCU for adjusting the vertical headlamp angle in accordance with aspects of this disclosure.

FIG. 5 is a flowchart illustrating a method for adjusting one or more headlamps to improve the ability of one or more perception sensor(s) to detect the roadway and/or objects in the environment in accordance with aspects of this disclosure.

### DETAILED DESCRIPTION

Vehicles traversing highways and roadways are legally required to comply with regulations and statutes in the course of safe operation of the vehicle. For autonomous vehicles (AVs), particularly autonomous tractor trailers, the ability to recognize a malfunction in its systems and stop safely are necessary for lawful and safe operation of the vehicle. Described below in detail are systems and methods for the safe and lawful operation of an autonomous vehicle on a roadway, including the execution of maneuvers that bring the autonomous vehicle in compliance with the law while signaling surrounding vehicles of its condition.

Aspects of this disclosure relate to systems and techniques which can automatically control the direction of swiveling headlamp(s) for autonomous driving. In particular, in relatively low-light conditions it can be desirable to provide lighting to improve the ability of certain sensor(s) to sense the environment.

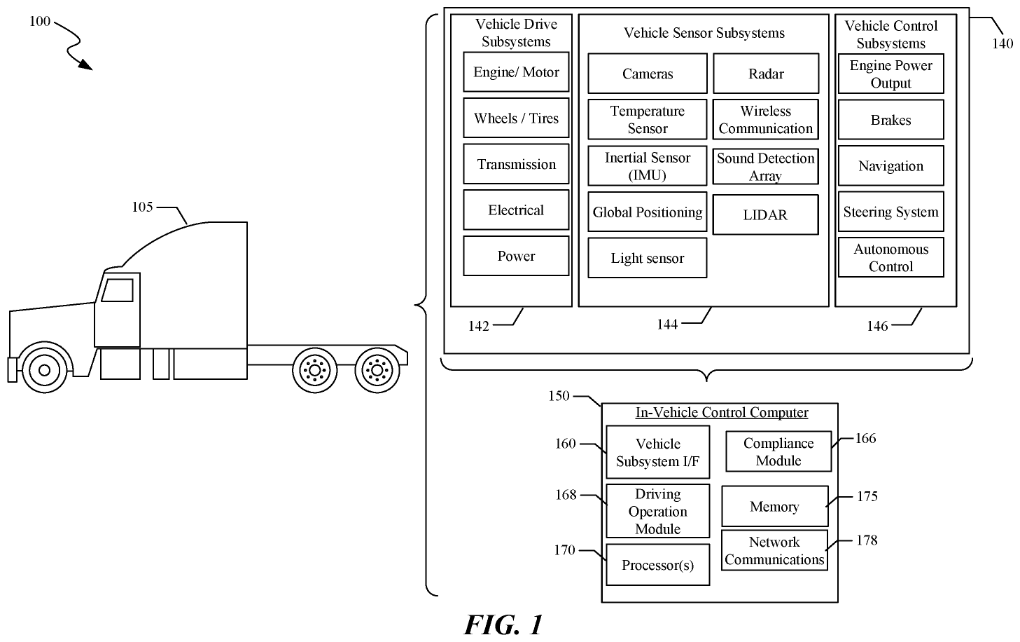

FIG. 1 shows a system 100 that includes a tractor 105 of an autonomous truck. The tractor 105 includes a plurality of vehicle subsystems 140 and an in-vehicle control computer 150. The plurality of vehicle subsystems 140 includes vehicle drive subsystems 142, vehicle sensor subsystems 144, and vehicle control subsystems. An engine or motor, wheels and tires, a transmission, an electrical subsystem, and a power subsystem may be included in the vehicle drive subsystems. The engine of the autonomous truck may be an internal combustion engine, a fuel-cell powered electric engine, a battery powered electrical engine, a hybrid engine, or any other type of engine capable of moving the wheels on which the tractor 105 moves. The tractor 105 have multiple motors or actuators to drive the wheels of the vehicle, such that the vehicle drive subsystems 142 include two or more electrically driven motors. The transmission may include a continuous variable transmission or a set number of gears that translate the power created by the engine into a force that drives the wheels of the vehicle. The vehicle drive subsystems may include an electrical system that monitors and controls the distribution of electrical current to components within the system, including pumps, fans, and actuators. The power subsystem of the vehicle drive subsystem may include components that regulate the power source of the vehicle.

Vehicle sensor subsystems 144 can include sensors for general operation of the autonomous truck 105, including those which would indicate a malfunction in the AV or another cause for an AV to perform a limited or minimal risk condition (MRC) maneuver. The sensors for general operation of the autonomous vehicle may include cameras, a temperature sensor, an inertial sensor (IMU), a global positioning system (GPS), a light sensor, a light detection and ranging (LiDAR) system, a radar system, and wireless communications.

A sound detection array, such as a microphone or array of microphones, may be included in the vehicle sensor subsystem 144. The microphones of the sound detection array are configured to receive audio indications of the presence of, or instructions from, authorities, including sirens and command such as “Pull over.” These microphones are mounted, or located, on the external portion of the vehicle, specifically on the outside of the tractor portion of an autonomous truck 105. Microphones used may be any suitable type, mounted such that they are effective both when the autonomous truck 105 is at rest, as well as when it is moving at normal driving speeds.

Cameras included in the vehicle sensor subsystems 144 may be rear-facing so that flashing lights from emergency vehicles may be observed from all around the autonomous truck 105. These cameras may include video cameras, cameras with filters for specific wavelengths, as well as any other cameras suitable to detect emergency vehicle lights based on color, flashing, of both color and flashing.

The vehicle control subsystem 146 may be configured to control operation of the autonomous vehicle, or truck, 105 and its components. Accordingly, the vehicle control subsystem 146 may include various elements such as an engine power output subsystem, a brake unit, a navigation unit, a steering system, and an autonomous control unit. The engine power output may control the operation of the engine, including the torque produced or horsepower provided, as well as provide control the gear selection of the transmission. The brake unit can include any combination of mechanisms configured to decelerate the autonomous vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the autonomous vehicle 105. The navigation unit may additionally be configured to update the driving path dynamically while the autonomous vehicle 105 is in operation. In some embodiments, the navigation unit may be configured to incorporate data from the GPS device and one or more predetermined maps so as to determine the driving path for the autonomous vehicle 105. The steering system may represent any combination of mechanisms that may be operable to adjust the heading of autonomous vehicle 105 in an autonomous mode or in a driver-controlled mode.

The autonomous control unit may represent a control system configured to identify, evaluate, and avoid or otherwise negotiate potential obstacles in the environment of the autonomous vehicle 105. In general, the autonomous control unit may be configured to control the autonomous vehicle 105 for operation without a driver or to provide driver assistance in controlling the autonomous vehicle 105. In some embodiments, the autonomous control unit may be configured to incorporate data from the GPS device, the RADAR, the LiDAR (e.g., LIDAR), the cameras, and/or other vehicle subsystems to determine the driving path or trajectory for the autonomous vehicle 105. The autonomous control that may activate systems that the autonomous vehicle 105 has which are not present in a conventional vehicle, including those systems which can allow the autonomous vehicle 105 to communicate with surrounding drivers or signal surrounding vehicles or drivers for safe operation of the autonomous vehicle 105.

The in-vehicle control computer 150, which may be referred to as a VCU, includes a vehicle subsystem interface 160, a driving operation module 168, one or more processors 170, a compliance module 166, a memory 175, and a network communications subsystem 178. This in-vehicle control computer 150 controls many, if not all, of the operations of the autonomous truck 105 in response to information from the various vehicle subsystems 140. The one or more processors 170 execute the operations that allow the system to determine the health of the autonomous vehicle 105, such as whether the autonomous vehicle 105 has a malfunction or has encountered a situation requiring service or a deviation from normal operation and giving instructions. Data from the vehicle sensor subsystems 144 is provided to VCU 150 so that the determination of the status of the autonomous vehicle 105 can be made. The compliance module 166 may determine what action should be taken by the autonomous truck 105 to operate according to the applicable (i.e., local) regulations. Data from other vehicle sensor subsystems 144 may be provided to the compliance module 166 so that the best course of action in light of the AV's status may be appropriately determined and performed. Alternatively, or additionally, the compliance module 166 may determine the course of action in conjunction with another operational or control module, such as the driving operation module 168.

The memory 175 may contain additional instructions as well, including instructions to transmit data to, receive data from, interact with, or control one or more of the vehicle drive subsystem 142, the vehicle sensor subsystem 144, and the vehicle control subsystem 146 including the autonomous control system. The in-vehicle control computer (VCU) 150 may control the function of the autonomous vehicle 105 based on inputs received from various vehicle subsystems (e.g., the vehicle drive subsystem 142, the vehicle sensor subsystem 144, and the vehicle control subsystem 146). Additionally, the VCU 150 may send information to the vehicle control subsystems 146 to direct the trajectory, velocity, signaling behaviors, and the like, of the autonomous vehicle 105. The vehicle control subsystems 146 may receive a course of action to be taken from the compliance module 166 of the VCU 150 and consequently relay instructions to other subsystems to execute the course of action.

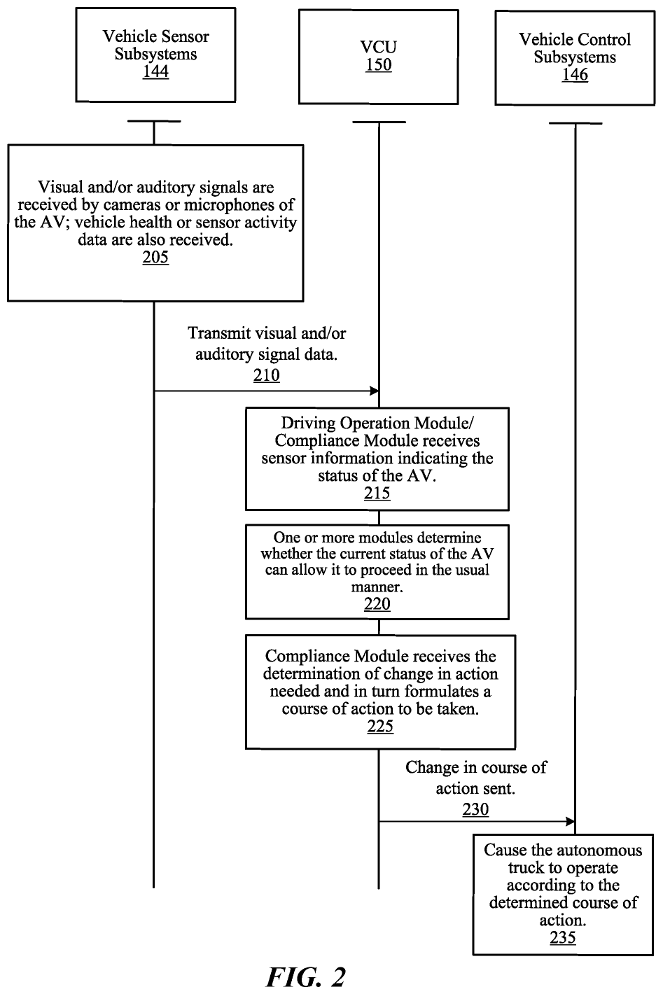

FIG. 2 shows a flow diagram for operation of an autonomous vehicle (AV) 105 safely in light of the health and surroundings of the autonomous vehicle 105. Although this figure depicts functional steps in a particular order for purposes of illustration, the process is not limited to any particular order or arrangement of steps. One skilled in the relevant art will appreciate that the various steps portrayed in this figure could be omitted, rearranged, combined and/or adapted in various ways.

As shown in FIG. 2, the vehicle sensor subsystems 144 may receive visual, auditory, or both visual and auditory signals indicating the environmental condition of the autonomous vehicle 105 in step 205. The vehicle sensor subsystems 144 may also receive vehicle health or sensor activity data in step 205. These visual and/or auditory signal data are transmitted from the vehicle sensor subsystems 144 to the in-vehicle control computer system (VCU) 150, as in step 210. The driving operation module 168 and/or the compliance module 166 may receive the data transmitted from the vehicle sensor subsystems 144, in step 215. One or both of those modules may determine whether the current status of the autonomous vehicle 105 can allow it to proceed in the usual manner or that the autonomous vehicle 105 needs to alter its course to prevent damage or injury or to allow for service in step 220. The information indicating that a change to the course of the autonomous vehicle 105 is needed may include an indicator of sensor malfunction; an indicator of a malfunction in the engine, brakes, or other components necessary for the operation of the autonomous vehicle 105; a determination of a visual instruction from authorities such as flares, cones, or signage; a determination of authority personnel present on the roadway; a determination of a law enforcement vehicle on the roadway approaching the autonomous vehicle 105, including from which direction; and a determination of a law enforcement or first responder vehicle moving away from or on a separate roadway from the autonomous vehicle 105. This information indicating that a change to the AV's course of action is needed may be used by the compliance module 166 to formulate a new course of action to be taken which accounts for the AV's health and surroundings, in step 225. The course of action to be taken may include slowing, stopping, moving into a shoulder, changing route, changing lane while staying on the same general route, and the like. The course of action to be taken may include initiating communications with an oversight system (e.g., a control center) or human interaction systems present on the autonomous vehicle 105. The course of action to be taken may then be transmitted from the VCU 150 to the vehicle control subsystems 146, in step 230. The vehicle control subsystems 146 then cause the autonomous vehicle 105 to operate in accordance with the course of action to be taken that was received from the VCU 150 in step 235.

It should be understood that the specific order or hierarchy of steps in the processes disclosed herein is an example of exemplary approaches. Based upon design preferences, it is understood that the specific order or hierarchy of steps in the processes may be rearranged while remaining within the scope of the present disclosure. The accompanying method claims present elements of the various steps in a sample order and are not meant to be limited to the specific order or hierarchy presented.

### Systems and Methods for Detecting Restricted Traffic Zones for Autonomous Driving

As described herein, aspects of this disclosure relate to systems and techniques which can automatically adjust one or more headlamps to improve the ability of one or more perception sensor(s) to detect the roadway and/or objects in the environment. For example, the headlamps can be adjusted to follow the curvature and/or grade of the roadway ahead of the autonomous vehicle 105 and/or illuminate one or more objects of interest in the environment. Certain perception sensor(s) 144 such as the camera(s) and/or LiDAR can benefit from lighting to improve the perception of object(s) and/or the environment within the area of illumination.

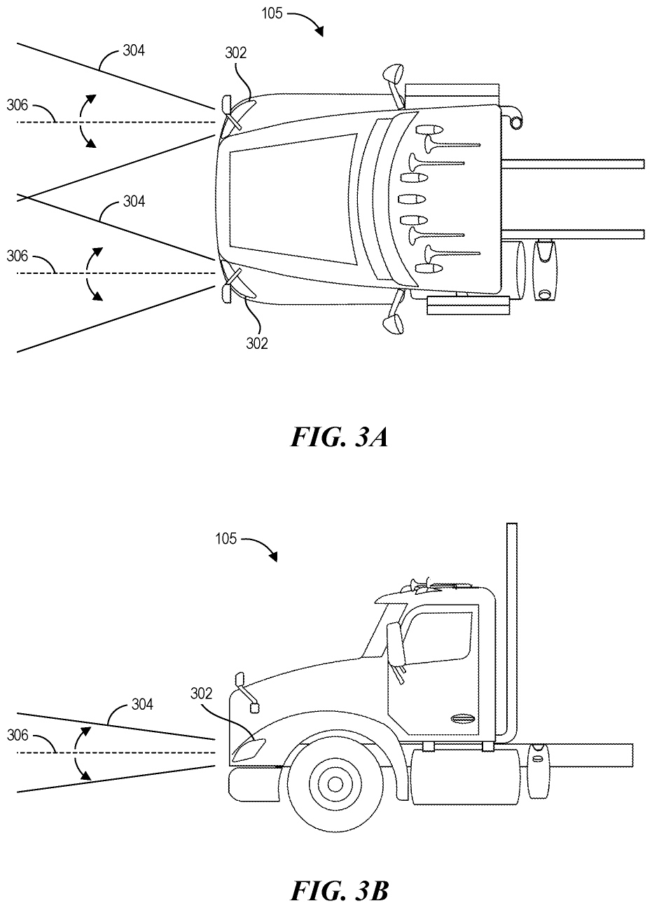

FIGS. 3A and 3B illustrate an autonomous vehicle 105 having one or more headlamp(s) 302 in accordance with aspects of this disclosure. The headlamp(s) 302 are configured to generate light 304. Although the light 304 is illustrated as being contained within a cone, is some embodiments the beam formed by the light 304 may have a different shape and/or there may not be a clear boundary for the light 304.

The one or more headlamp(s) 302 are configured to direct the light 304 in a specific direction 306. Each of the headlamp(s) 302 may also include one or more actuators configured to adjust the direction 306 in which the light 304 is emitted. Depending on the implementation, each headlamp 302 can independently adjust the direction 306 of the light both horizontally and vertically. In some embodiments, the headlamps 302 can include regular headlamps, daylight headlamps, low-light headlamps, and/or fog lamps, each of which can be independently turned on/off, adjusted in intensity, and/or pointed in a different direction. In some embodiments, each headlamp 302 can further adjust the amount of light emitted from the headlamp 302 (e.g., via dimming) and/or the size of the beam of light 304 emitted from the headlamp 302 (e.g., the taper of a cone representing the beam of light 304).

Each of the headlamps 302 may be independently controlled via the in-vehicle control computer (VCU) 150 (also referred to herein simply as a “processor”), which may receive one or more inputs which the VCU 150 can use to determine how to adjust the headlamps 302. As described herein, the VCU 150 can execute one or more headlamp control algorithms (e.g., the horizontal headlamp control algorithm 402 and the vertical headlamp control algorithm 452) configured to adjust the angle in which each of the headlamps 302 is directed based on one or more inputs.

Depending on the implementation, the headlamp control algorithm(s) 402, 452 can adjust each headlamp angle based on one or more of: a navigational map, a point of interest (e.g., an object or area of interest), and/or feedback from one or more perception sensors. For example, the navigational map can provide information on road curvature and/or road slope, which can be used to adjust the direction of the headlamps 302 such that the road ahead of the autonomous vehicle 105 is sufficiently illuminated. The point(s) of interest can be part of a request for illumination generated by a separate system (e.g., an autonomy system). In some embodiments, the headlamp control algorithm(s) 402, 452 can control two or more headlamps 302 to illuminate the point(s) of interest, thereby concentrating light 304 on the same object(s) to improve perception results. The headlamp control algorithm(s) 402, 452 can also provide additional illumination by increasing the amount of light 304 provided by one or more of the headlamp(s) 302. The headlamp control algorithm(s) 402, 452 can also use feedback from one or more perception sensors in controlling the headlamp angle(s), for example, by detecting regions(s) and/or object(s) in the output of the perception sensor(s) that have insufficient illumination. The feedback may also include object detection based on the output of the perception sensor(s) to identify object(s) in the environment that could benefit from additional illumination to improve the perception results of the detected object(s).

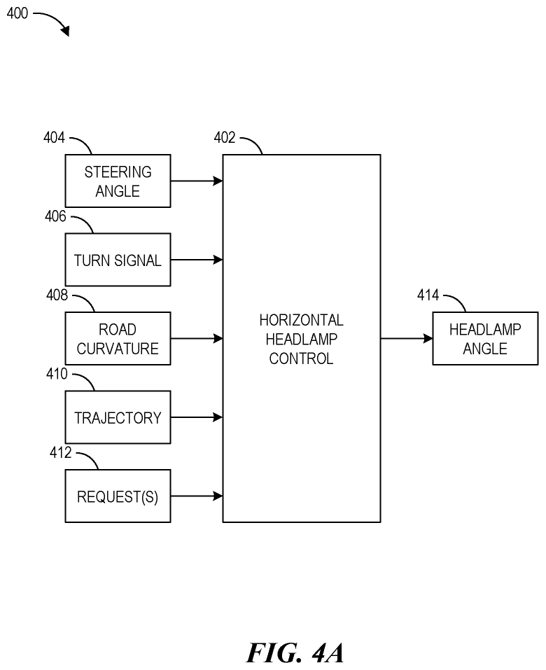

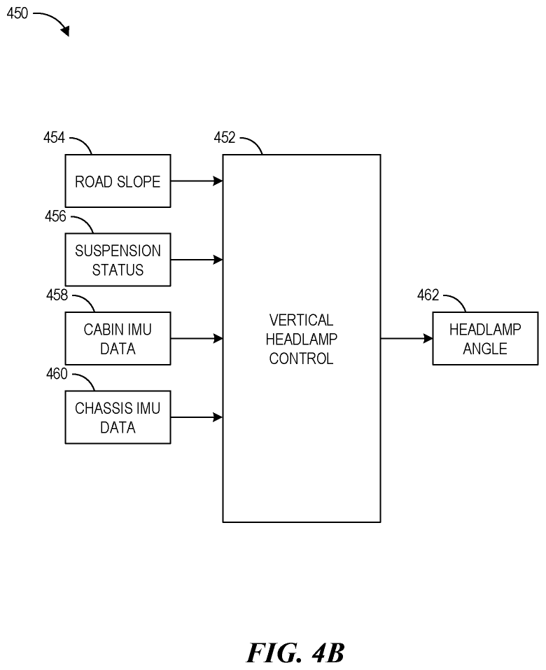

FIG. 4A is a block diagram 400 illustrating an embodiment of a horizontal headlamp control algorithm 402 that can be run by the VCU 150 for adjusting the horizontal headlamp angle 414 in accordance with aspects of this disclosure. FIG. 4B is a block diagram 450 illustrating an embodiment of a vertical control algorithm 452 that can be run by the VCU 150 for adjusting the vertical headlamp angle 462 in accordance with aspects of this disclosure. Although the horizontal and vertical control algorithms 402, 452 are illustrated as being independent of each other, in certain embodiments the headlamp control algorithms 402, 452 can be combined to generate a single two-dimensional headlamp angle that controls both the horizontal and vertical angle 414, 462 of each headlamp 302. In some embodiments, the headlamp control algorithms 402, 452 can provide commands to one or more actuators configured to control the orientation of the headlamp(s) 302, and thus the direction 306 in which light 304 is emitted from the headlamp(s) 302.

With reference to FIG. 4A, the horizontal headlamp control algorithm 402 can receive one or more of the following inputs: a steering angle 404, a turn signal 406, a road curvature 408, a trajectory 410, and one or more request(s) 412. However, depending on the implementation, the horizontal headlamp control algorithm 402 may receive a greater or fewer number of inputs, for example, the horizontal headlamp control algorithm 402 may also receive inputs indicative of the weather, the current lighting (e.g., from an ambient light sensor), current traffic conditions, etc. Using the inputs 404-412, the horizontal headlamp control algorithm 402 can determine a horizontal headlamp angle 414 for the headlamps 302. Although portions of the following description may refer to the headlamps 302 together, in some implementations, the horizontal headlamp control algorithm 402 can determine an independent horizontal headlamp angle 414 for each headlamp 302 independently.

In some embodiments, the horizontal headlamp control algorithm 402 can use the steering angle 404 input as a baseline for determining the horizontal headlamp angle 414. For example, when all of the other inputs are neutral or non-existent, the horizontal headlamp control algorithm 402 can determine the horizontal headlamp angle 414 based on the steering angle 404 input alone. In some implementations, the horizontal headlamp control algorithm 402 can first determine a baseline horizontal headlamp angle and then determine the horizontal headlamp angle 414 by adjusting the baseline horizontal headlamp angle based on the remaining inputs 406-412. In some embodiments, the adjustment to the baseline horizontal headlamp angle can be an incrementally changed or can completely replace the baseline horizontal headlamp angle when the adjustment has a priority above a threshold priority level.

Depending on the implementation, the horizontal headlamp control algorithm 402 can determine the baseline horizontal headlamp angle based on a function of the steering angle 404 input. For example, when the steering angle 404 input is zero, the baseline horizontal headlamp angle may also be zero, e.g., in the same direction as the orientation of the autonomous vehicle 105. The horizontal headlamp control algorithm 402 can adjust the baseline horizontal headlamp angle based on linear relationship with the steering angle 404 input. However, in other embodiments, the baseline horizontal headlamp angle may have other functional relationships with the steering angle 404 input.

In some embodiments, the horizontal headlamp control algorithm 402 can use the turn signal 406 input to adjust the baseline horizontal headlamp angle. For example, the horizontal headlamp control algorithm 402 can adjust the baseline horizontal headlamp angle by an adjustment angle based on whether the turn signal 406 is active. The adjustment angle may be a predetermined angle, or in some embodiments, the adjustment angle may be based on the current direction (e.g., heading) of the baseline horizontal headlamp angle 414. For example, if the baseline horizontal headlamp angle is within a predetermined distance of the maximum angle achievable by the headlamp 302.

As shown in FIG. 4A, the horizontal headlamp control algorithm 402 can also receive the road curvature 408 input, for example, from a navigational (e.g., high definition) map stored in memory 175. In some embodiments, the horizontal headlamp control algorithm 402 can receive the navigational map and determine the road curvature 408 based on the navigational map. The horizontal headlamp control algorithm 402 can adjust the baseline horizontal headlamp angle such that the portion of the road curvature 408 within range of the light 304 emitted by the headlamps 302 is illuminated by the headlamps 302. In some embodiments, the horizontal headlamp control algorithm 402 can also adjust the baseline horizontal headlamp angle based on the road curvature 408 input to account for the curvature of the roadway ahead of the range of the light 304 emitted by the headlamps 302. For example, the horizontal headlamp control algorithm 402 can begin adjusting the angle of the baseline horizontal headlamp angle such that the headlamps 302 begin moving in the direction of curvature of the roadway that is not yet in range of the light 304 emitted by the headlamps 302. In this way, the horizontal headlamp control algorithm 402 can predict a desired horizontal headlamp angle 414 to account for the road curvature 408 ahead of the autonomous vehicle 105 and adjust the horizontal headlamp angle 414 before the road curvature 408 is in range of the light 304 emitted by the headlamps 302.

The horizontal headlamp control algorithm 402 can also receive the trajectory 410 input, for example, from a planner algorithm running on the VCU 150. The planner algorithm can be configured to determine a lane-level trajectory 410 (or a sub-lane level trajectory) for the autonomous vehicle 105 based on a route of the autonomous vehicle 105. The horizontal headlamp control algorithm 402 can determine an adjustment to the baseline horizontal headlamp angle for each headlamp 302 based on the trajectory 410 input such that the roadway corresponding to the anticipated trajectory 410 of the autonomous vehicle 105 is sufficiently illuminated.

In one embodiment, the horizontal headlamp control algorithm 402 can use the trajectory 410 input to adjust the baseline horizontal headlamp angle in order to assist in providing illumination during an active lane change. For example, the horizontal headlamp control algorithm 402 can use a combination of the steering angle 404 input, the turn signal 406 input, the trajectory 410 input, and/or the request 412 input to determine that the autonomous vehicle 105 will or is currently executing a lane change. Based on the determination that the autonomous vehicle 105 will or is currently executing a lane change, the horizontal headlamp control algorithm 402 can adjust the baseline horizontal headlamp angle in the direction of the lane change to provide increased illumination of the area into which the autonomous vehicle 105 will proceed during the lane change. Depending on the embodiment, the horizontal headlamp control algorithm 402 may not make an explicit determination will or is currently executing a lane change, but rather adjusts the baseline horizontal headlamp angle in the direction of a lane change based on the combination of one or more of the steering angle 404 input, the turn signal 406 input, the trajectory 410 input, and/or the request 412 input.

The horizontal headlamp control algorithm 402 can also receive one or more requests 412 from an autonomy system (which may include or receive input from an object detection algorithm) running on the VCU 150. The autonomy system may evaluate data from one or more sensor systems and, in combination with one or more maps stored on the autonomous vehicle 105, determine a path and trajectory for the autonomous vehicle 105. When sensor data quality falls below a threshold, or it is determined that sensor data quality may improve with better illumination, a request may be sent by the autonomy system to the headlamp control algorithm 402 or the illumination system. Each of the request(s) 412 can identify a point of interest (e.g., an object of interest and/or an area of interest) for which it may be important to provide sufficient illumination for at least some of the perception sensors to improve perception of the point of interest. The horizontal headlamp control algorithm 402 can adjust the baseline horizontal headlamp angle such that at least one of the headlamps 302 illuminates the object or area identified by the one or more requests 412. When there are two or more requests 412, the horizontal headlamp control algorithm 402 can adjust the baseline horizontal headlamp angle for a corresponding number of the headlamps 302 such that each of the objects and/or areas identified by the requests 412 can be illuminated. In some implementations, the horizontal headlamp control algorithm 402 can adjust two or more of the headlamps 302 toward the same point of interest to concentrate light to the same point to improve perception results. Example objects which may be identified by the requests 412 include: pedestrians, other vehicles, static objects (e.g., trees, signs, etc.), and dynamic objects (e.g., animals, bicyclists, etc.).

In some embodiments, a request 412 may also include an indication of a priority associated with the request. For example, the autonomy system may assign a priority level to the corresponding point of interest that represents the importance of obtaining better quality perception of the point of interest. In some implementations, when the priority level of a given request is above a threshold priority level, the horizontal headlamp control algorithm 402 can determine a horizontal headlamp angle 414 to illuminate the point of interest while overriding the baseline horizontal headlamp angle.

In one example situation, a request may identify a pedestrian as an object of interest. If the pedestrian is located outside of the current area illuminated by the headlamps 302, the horizontal headlamp control algorithm 402 can determine the horizontal headlamp angle 414 such that one or more of the headlamps illuminates an area including the pedestrian in order to improve perception results.

The horizontal headlamp control algorithm 402 can also be configured to adjust the baseline horizontal headlamp angle based on one or more other inputs, for example, the weather, the current lighting (e.g., from an ambient light sensor), current traffic conditions, feedback from one or more perception sensor(s), time of day, etc. In one example, the feedback from one or more perception sensor(s) can include feedback from a camera indicating there is a certain region within the camera's field of view lacking illumination (e.g., having a measured level of illumination below a threshold). In response, the horizontal headlamp control algorithm 402 (and/or the vertical headlamp control algorithm 452 discussed below) can adjust the headlamp angle to provide additional illumination of the identified region. In another example, the feedback may indicate areas of excessive reflection (e.g., reflections with a brightness above a threshold level) from the light provided by one or more of the headlamp(s) 302, such as reflections from puddles on the road. In response, the horizontal headlamp control algorithm 402 (and/or the vertical headlamp control algorithm 452 discussed below) can adjust the headlamp angle to reduce the reflection below the threshold level.

In summary, the horizontal headlamp control algorithm 402 can generate the horizontal headlamp angle 414 for the headlamps 302, either collectively or individually, using any combination of the available inputs 404-412. The horizontal headlamp control algorithm 402 can output the horizontal headlamp angle 414 as a command to adjust the direction of each of the headlamps 302.

With reference to FIG. 4B, the vertical headlamp control algorithm 452 can receive one or more of the following inputs: a road slope 454, a suspension status 456, cabin IMU data 458, and chassis IMU data 460. However, depending on the implementation, the vertical headlamp control algorithm 452 may receive a greater or fewer number of inputs, for example, the vertical headlamp control algorithm 452 may also receive inputs indicative of the weather, the current lighting (e.g., from an ambient light sensor), current traffic conditions, etc. Using the inputs 454-460, the vertical headlamp control algorithm 452 can determine a vertical headlamp angle 462 for the headlamps 302. Although portions of the following description may refer to the headlamps 302 together, in some implementations, the vertical headlamp control algorithm 452 can determine an independent vertical headlamp angle 462 for each headlamp 302 independently.

In some implementations, the vertical headlamp control algorithm 452 can use the road slope 454 input as a baseline for determining the vertical headlamp angle 462. For example, when all of the other inputs are neutral or non-existent, the vertical headlamp control algorithm 452 can determine the vertical headlamp angle 462 based on the road slope 454 alone. In some implementations, the vertical headlamp control algorithm 452 can first determine a baseline vertical headlamp angle and then determine the vertical headlamp angle 462 by adjusting the baseline vertical headlamp angle based on the remaining inputs 456-460. In some embodiments, the adjustment to the baseline vertical headlamp angle can be an incrementally changed or can completely replace the baseline vertical headlamp angle when the adjustment has a priority above a threshold priority level.

The vertical headlamp control algorithm 452 can receive the road slope 454 input, for example, from a navigational (e.g., high definition) map stored in memory 175. The vertical headlamp control algorithm 452 can determine the baseline vertical headlamp angle such that the portion of roadway within range of the light 304 emitted by the headlamps 302 is illuminated by the headlamps 302. For example, when the road slope 454 input indicates that the road is sloping up ahead of the autonomous vehicle 105, the vertical headlamp control algorithm 452 can adjust the vertical headlamp angle 462 upwards based on the amount of slope (e.g., the grade of the roadway), and vice versa when the road is sloping down ahead of the autonomous vehicle 105. In some embodiments, the vertical headlamp control algorithm 452 can also determine the baseline vertical headlamp angle based on the road slope 454 input to account for the slope of the roadway ahead of the range of the light 304 emitted by the headlamps 302. For example, the vertical headlamp control algorithm 452 can begin adjusting the angle of the baseline vertical headlamp angle such that the headlamps 302 begin moving in the direction of slope of the roadway that is not yet in range of the light 304 emitted by the headlamps 302.

The vertical headlamp control algorithm 452 can receive the suspension status 456, the cabin IMU data 458, and the chassis IMU data 460 from respective sensors of the vehicle sensor subsystems 144. For example, the vehicle sensor subsystems 144 can include one or more suspension sensors configured to measure the relative position of the autonomous vehicle's 105 chassis and wheels. Depending on the embodiment, the autonomous vehicle 105 may have one or more suspension sensors per wheel, or may include a plurality of suspension sensor located at representative locations around the autonomous vehicle 105 (e.g., near the four corners for the autonomous vehicle 105). The vehicle sensor subsystems 144 can further include one or more cabin IMUs and one or more chassis IMUs. The cabin IMU can be configured to generate the cabin IMU data 458 (e.g., inertial data for the cabin of the autonomous vehicle 105). Similarly, the chassis IMU can be configured to generate the chassis IMU data 460 (e.g., inertial data for the chassis of the autonomous vehicle 105).

The vertical headlamp control algorithm 452 can determine the orientation of the autonomous vehicle 105, which can include the orientation of the cabin and/or the headlamps 302, based on one or more of the suspension status 456, the cabin IMU data 458, and the chassis IMU data 460. In some embodiments, the vertical headlamp control algorithm 452 determines the pitch of the cabin of the autonomous vehicle 105. The vertical headlamp control algorithm 452 can also determine the current dynamics of the autonomous vehicle 105 with respect to the ground based on the cabin IMU data 458 and the chassis IMU data 460. For example, the vertical headlamp control algorithm 452 can determine a current velocity and acceleration representing changes in the orientation of the autonomous vehicle 105. The vertical headlamp control algorithm 452 can also predict changes to the orientation and/or dynamics of autonomous vehicle 105 based on the suspension status 456, the cabin IMU data 458, and the chassis IMU data 460. The vertical headlamp control algorithm 452 can adjust the baseline vertical headlamp angle based on the orientation and/or dynamics of the autonomous vehicle 105, thereby generating the vertical headlamp angle 462.

The vertical headlamp control algorithm 452 may also receive other inputs used in adjusting the vertical headlamp angle 462. For example, the vertical headlamp control algorithm 452 may receive current or predicted weather conditions for the location of the autonomous vehicle 105. In one example, when the weather conditions indicate that the autonomous vehicle 105 is in a foggy area, vertical headlamp control algorithm 452 may adjust the baseline vertical headlamp angle down to reduce reflections from the fog back to the perception sensors. Other inputs used to adjust the positioning of the headlamp may include a large number of particulates in the air (e.g., ash, dust, and the like), an occurrence of an eclipse, emergence of the autonomous vehicle 105 from a tunnel or covered area, entrance of the autonomous vehicle 105 into a tunnel or other covered area, the occurrence of a blackout which causes streetlamps to malfunction, the use of floodlights or auxiliary lighting (e.g., by construction crews working at night), and any other situation where there is a quick transition in lighting or an anomaly in lighting as compared to what occurs on a day to day basis in an area. Further, the time of day, as well as the time of year, may cause adverse lighting conditions in locations that otherwise do not require specialized lighting from headlamps in order for an autonomous vehicle 105 to safely traverse. For example, a roadway on which autonomous vehicles 105 travel eastward may require special lighting early in the morning as the sun rises.

The VCU 150 can further be configured to collect the output of the perception sensors (e.g., the camera(s) and/or LiDAR(s)) in combination with the inputs provided to and outputs generated by the horizontal and vertical headlamp control algorithms 402, 452. This data can be provided to oversight system (e.g., a control center) for analysis. For example, the oversight system can evaluate the performance of the headlamp control algorithms 402, 452 by determining how well the headlamps 302 are directed to illuminate the environment based on the corresponding inputs. This evaluation can be used to update and improve the headlamp control algorithms 402, 452 for future use and the updated headlamp control algorithms 402, 452 can be provided to a plurality of autonomous vehicles 105 within a fleet.

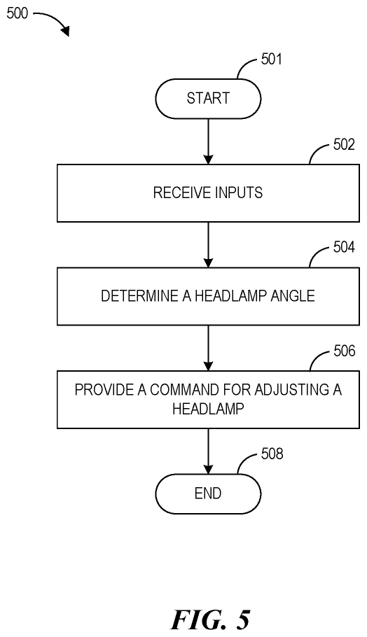

FIG. 5 is a flowchart illustrating a method 500 for adjusting one or more headlamps 302 to improve the ability of one or more perception sensor(s) to detect the roadway and/or objects in the environment in accordance with aspects of this disclosure. With reference to FIG. 5, one or more blocks of the method 500 may be implemented, for example, by a processor such as the VCU 150 of the autonomous vehicle 105. The method 500 begins at block 501.

At block 502, the VCU 150 receives one or more inputs including a navigational map. Depending on the embodiment, the inputs can include: a steering angle 404, a turn signal 406, a road curvature 408 (e.g., determined based on the navigational map), a trajectory 410 of the autonomous vehicle 105, one or more request(s) 412, a road slope 454 (e.g., determined based on the navigational map), a suspension status 456, cabin IMU data 458, and chassis IMU data 460.

At block 504, the VCU 150 determines a headlamp angle 414 based at least in part on the navigational map. In some embodiments, the VCU 150 can independently determine a horizontal headlamp angle 414 and a vertical headlamp angle 462, however, aspects of this disclosure are not limited thereto. The VCU 150 can determine the headlamp angle in order to increase the illumination of area(s) and/or object(s) for detection by one or more perception sensors (e.g., camera(s), LiDAR, etc.) of the autonomous vehicle 105.

At block 506, the VCU 150 provides a command to at least one actuator to adjust an orientation of at least one headlamp 302 based on the headlamp angle. The method 500 ends at block 508.

### CONCLUSION

Though much of this document refers to an autonomous truck, it should be understood that any autonomous ground vehicle may have such features. Autonomous vehicles which traverse over the ground may include: semis, tractor-trailers, 18 wheelers, lorries, class 8 vehicles, passenger vehicles, transport vans, cargo vans, recreational vehicles, golf carts, transport carts, and the like.

While several embodiments have been provided in this disclosure, it should be understood that the disclosed systems and methods might be embodied in many other specific forms without departing from the spirit or scope of this disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of this disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

What is claimed is:

1. An autonomous vehicle comprising:
at least one headlamp configured to emit light in a direction to illuminate an environment of the autonomous vehicle;
at least one actuator configured to adjust the direction;
at least one perception sensor configured to generate data based at least in part on the light emitted from the at least one headlamp; and
a processor configured to:
receive one or more inputs including a navigational map,
determine a headlamp angle based at least in part on the navigational map, and
provide a command to the at least one actuator to adjust the direction based on the headlamp angle.

2. The autonomous vehicle of claim 1, wherein the one or more inputs further include a steering angle, and the processor is further configured to:
determine a baseline horizontal headlamp angle based on the steering angle.

3. The autonomous vehicle of claim 2, wherein the baseline horizontal headlamp angle is further determined based on a linear relationship with the steering angle.

4. The autonomous vehicle of claim 2, wherein the one or more inputs further include a turn signal, and the processor is further configured to:
adjust the baseline horizontal headlamp angle based on the turn signal.

5. The autonomous vehicle of claim 1, wherein the processor is further configured to:
determine a road curvature based on the navigational map,
wherein determining the headlamp angle is further based at least in part on the road curvature.

6. The autonomous vehicle of claim 5, wherein determining the headlamp angle based on the road curvature illuminates a portion of the road curvature within range of the light emitted by the at least one headlamp.

7. The autonomous vehicle of claim 5, wherein determining the headlamp angle based on the road curvature takes into account for the road curvature of a roadway not yet within range of the light emitted by the headlamps.

8. The autonomous vehicle of claim 1, wherein the one or more inputs further include a trajectory of the autonomous vehicle.

9. The autonomous vehicle of claim 8, wherein determining the headlamp angle based on the trajectory sufficiently illuminates a roadway corresponding to the trajectory of the autonomous vehicle.

10. The autonomous vehicle of claim 1, wherein the one or more inputs further include a steering angle, a turn signal input, and a trajectory of the autonomous vehicle, and the processor is further configured to:
determine that the autonomous vehicle will or is currently executing a lane change,
wherein determining the headlamp angle is further based on the determination that the autonomous vehicle will or is currently executing the lane change.

11. A method performed by a processor of an autonomous vehicle, comprising:
receiving one or more inputs including a navigational map;
determining a headlamp angle based at least in part on the navigational map; and
providing a command to at least one actuator to adjust an orientation of at least one headlamp based on the headlamp angle.

12. The method of claim 11, wherein the one or more inputs further include a request identifying a point of interest, and wherein determining the headlamp angle is further based on the point of interest.

13. The method of claim 11, wherein:
the at least one headlamp comprises a plurality of headlamps,
the one or more inputs further include a plurality of requests, each of the requests identifying a corresponding point of interest,
determining the headlamp angle comprises determining a headlamp angle for each of the plurality of headlamps based on one of the points of interest, and
providing the command comprises providing a command to each of the plurality of headlamps based on the corresponding headlamp angles.

14. The method of claim 11, wherein the one or more inputs further include at least one of the following: a weather input, current lighting, current traffic conditions, feedback from one or more perception sensors of the autonomous vehicle, and a time of day.

15. The method of claim 11, wherein:
the one or more inputs further comprise receiving feedback from a camera of the autonomous vehicle indicating there is a certain region within a field of view of the camera that has a measured level of illumination below a threshold, and
determining the headlamp angle is further based on the feedback from the camera.

16. The method of claim 11, further comprising:
determining a road slope based on the navigational map; and
determining a baseline headlamp angle based at least in part on the road slope.

17. The method of claim 16, wherein the one or more inputs further comprise at least one of a suspension status, cabin inertial sensor (IMU) data, and chassis IMU data, and the method further comprises:
determining an orientation of the autonomous vehicle based on the one or more inputs; and
adjusting the baseline headlamp angle based on the orientation of the autonomous vehicle;
wherein determining the headlamp angle is further based on the adjusted baseline headlamp angle.

18. A non-transitory computer-readable medium having stored thereon instructions that, when executed by a processor, cause the processor to:
receive one or more inputs including a navigational map;
determine a headlamp angle based at least in part on the navigational map; and
provide a command to at least one actuator to adjust an orientation of at least one headlamp based on the headlamp angle.

19. The non-transitory computer-readable medium of claim 18, wherein the determined headlamp angle comprises a horizontal headlamp angle and a vertical headlamp angle.

20. The non-transitory computer-readable medium of claim 19, wherein the horizontal headlamp angle and the vertical headlamp angle are determined independently.
